(19) United States
(12) Patent Application Publication
(10) Pub. No.: US 2012/0170047 A1
(43) Pub. Date: Jul. 5, 2012

(54) SYSTEM AND METHOD FOR MEASURING A DISTANCE

(75) Inventors: John H. Hong, San Clemente, CA (US); Jian Ma, Carlsbad, CA (US); Tallis Y. Chang, San Diego, CA (US)

(73) Assignee: QUALCOMM MEMS TECHNOLOGIES, INC., San Diego, CA (US)

(21) Appl. No.: 12/983,527

(22) Filed: Jan. 3, 2011

(51) Int. Cl. G01B 9/02

(52) U.S. Cl. 356/482

(57) ABSTRACT

This disclosure provides systems, methods and apparatus, including computer programs encoded on computer storage media, for measuring a distance. In one aspect, the method includes actuating or releasing an interferometric modulator having a first surface and a second surface and measuring a distance between the first and second surfaces at a plurality of times during the actuation or release. In another aspect, the method includes illuminating, with a first laser beam having a first wavelength and with a second laser beam having a second wavelength different from the first wavelength, an interferometric modulator having a distance between a first surface which is at least partially reflective and a second surface which is at least partially absorptive, measuring a first intensity of the first laser beam modulated by the interferometric modulator and a second intensity of the second laser beam modulated by the interferometric modulator, and determining the distance based on the measured intensities.

### TECHNICAL FIELD

This disclosure relates to measuring a distance in electromechanical systems, and in particular, to measuring a gap distance of an interferometric modulator.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

### SUMMARY

The systems, methods and devices of the disclosure each have several innovative aspects, no single one of which is solely responsible for the desirable attributes disclosed herein.

One innovative aspect of the subject matter described in this disclosure can be implemented in a method of determining a distance includes actuating or releasing an interferometric modulator and measuring a gap distance of the interferometric modulator at a plurality of times during the actuation or release.

In some implementations, actuating or releasing an interferometric modulator includes periodically actuating and releasing the interferometric modulator at a first periodicity and measuring a gap distance of the interferometric modulator at a plurality of times during the actuation or release includes periodically measuring a gap distance of the interferometric modulator at a second periodicity different from the first periodicity.

In some implementations, measuring a gap distance of the interferometric modulator includes measuring a plurality of gap distances at a respective plurality of locations within the interferometric modulator.

In some implementations, a system for determining a distance includes a voltage source configured to actuate or release an interferometric modulator and a meter configured to measure a gap distance of the interferometric modulator at a plurality of times during the actuation or release.

In some implementations, the system includes a first laser source configured to emit a first laser beam having a first wavelength, a second laser source configured to emit a second laser beam having a second wavelength different from the first wavelength, and a detector configured to determine a first intensity of the first laser beam reflected from the interferometric modulator and a second intensity of the second laser beam reflected from the interferometric modulator.

In some implementations, the voltage source is configured to periodically actuate and release the interferometric modulator at a first periodicity and the processor is configured to periodically determine a distance between the first and second surfaces at a second periodicity different from the first periodicity.

In some implementations, the processor is configured to determine a plurality of distances between the first and second surfaces at a respective plurality of locations of the interferometric modulator.

In some other implementations, a system for determining a distance includes means for actuating or releasing an interferometric modulator and means for measuring a gap distance of the interferometric modulator at a plurality of times during the actuation or release.

In some implementations, the system includes means for emitting a first laser beam having a first wavelength, means for emitting a second laser beam having a second wavelength different from the first wavelength, and means for determining a first intensity of the first laser beam reflected from the interferometric modulator and a second intensity of the second laser beam reflected from the interferometric modulator.

In some implementations, the system includes means for expanding a laser beam into a plurality of beams and/or means for expanding a laser beam into a plane.

In some implementations, a computer-readable storage medium having computer-executable instructions encoded thereon for performing a method of determining a distance, the method including actuating or releasing an interferometric modulator and measuring a gap distance of the interferometric modulator at a plurality of times during the actuation or release.

In some implementations, actuating or releasing an interferometric modulator includes periodically actuating and releasing the interferometric modulator at a first periodicity and measuring a gap distance of the interferometric modulator at a plurality of times during the actuation or release includes periodically measuring a gap distance of the interferometric modulator at a second periodicity different from the first periodicity.

In some implementations, measuring a gap distance of the interferometric modulator includes measuring a plurality of gap distances at a respective plurality of locations within the interferometric modulator.

In some implementations, a method of determining a distance between two surfaces includes illuminating, with a first laser beam having a first wavelength and with a second laser beam having a second wavelength different from the first wavelength, an interferometric modulator having a distance between a first surface which is at least partially reflective and a second surface which is at least partially absorptive, measuring a first intensity of the first laser beam modulated by the interferometric modulator and a second intensity of the second laser beam modulated by the interferometric modulator, and determining the distance based on the measured intensities.

In some implementations, the method includes illuminating the interferometric modulator with a third laser beam having a third wavelength and measuring a third intensity of the third laser beam modulated by the interferometric modulator.

In some implementations, determining the distance includes determining the distance at a plurality of times during an actuation or release of the interferometric modulator.

In some implementations, a system for determining a distance between two surfaces includes a first laser source configured to emit a first laser beam having a first wavelength towards an interferometric modulator having a distance between a first surface which is at least partially reflective and a second surface which is at least partially absorptive, a second laser source configured to emit a second laser beam having a second wavelength towards the interferometric modulator, a first detector configured to measure a first intensity of the first laser beam reflected by the interferometric modulator, a second detector configured to measure a second intensity of the second laser beam reflected by the interferometric modulator, and a processor configured to determine the distance based on the measured intensities.

In some implementations, the system includes a linear translation platform configured to move the interferometric modulator.

In some implementations, the system includes a third laser source configured to emit a third laser beam having a third wavelength towards the interferometric modulator and the detector is further configured to measure a third intensity of the third laser beam modulated by the interferometric modulator.

In some other implementations, a system for determining a distance between two surfaces includes means for illuminating, with a first laser beam having a first wavelength and with a second laser beam having a second wavelength different from the first wavelength, an interferometric modulator having a distance between a first surface which is at least partially reflective and a second surface which is at least partially absorptive, means for measuring a first intensity of the first laser beam modulated by the interferometric modulator and a second intensity of the second laser beam modulated by the interferometric modulator, and means for determining the distance based on the measured intensities.

In some implementations, the means for illuminating is configured to illuminate, with a third laser beam having a third wavelength, the interferometric modulator and the means for measuring is configured to measure a third intensity of the third laser beam modulated by the interferometric modulator.

In some implementations, a computer-readable storage medium having computer-executable instructions encoded thereon for performing a method of determining a distance between two surfaces, the method including illuminating, with a first laser beam having a first wavelength and with a second laser beam having a second wavelength different from the first wavelength, an interferometric modulator having a distance between a first surface which is at least partially reflective and a second surface which is at least partially absorptive, measuring a first intensity of the first laser beam modulated by the interferometric modulator and a second intensity of the second laser beam modulated by the interferometric modulator, and determining the distance based on the measured intensities.

In some implementations, determining the distance includes determining the distance at a plurality of times during an actuation or release of the interferometric modulator.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3A shows an example of a diagram illustrating movable reflective layer position versus applied voltage for the interferometric modulator of FIG. 1.

FIG. 3B shows an example of a table illustrating various states of an interferometric modulator when various common and segment voltages are applied.

FIG. 4A shows an example of a diagram illustrating a frame of display data in the 3×3 interferometric modulator display of FIG. 2.

FIG. 4B shows an example of a timing diagram for common and segment signals that may be used to write the frame of display data illustrated in FIG. 4A.

FIG. 5A shows an example of a partial cross-section of the interferometric modulator display of FIG. 1.

FIGS. 5B-5E show examples of cross-sections of varying implementations of interferometric modulators.

FIG. 6 shows an example of a flow diagram illustrating a manufacturing process for an interferometric modulator.

FIGS. 7A-7E show examples of cross-sectional schematic illustrations of various stages in a method of making an interferometric modulator.

FIG. 8 shows an example of a graph of a reflectance versus gap distance at two different wavelengths for an implementation of an interferometric modulator.

FIG. 9 shows an example of a functional block diagram of a system for determining a distance between two surfaces.

FIG. 10 shows an example of a functional block diagram of a system for determining a distance between two surfaces at a number of different locations.

FIG. 11A shows an example of a plot of laser emission versus time.

FIG. 11B shows an example of a plot of applied voltage versus time.

FIG. 11C shows an example of a plot of gap distance versus time.

FIG. 12 shows an example of a functional block diagram of a system for determining a determining a distance between two surfaces at a number of different times during actuation or release.

FIG. 13 shows an example of a functional block diagram of a system for determining a determining a distance between two surfaces along a line at a number of different times during actuation or release.

FIGS. 14 and 15 show examples of a flowchart illustrating a method of determining a distance.

FIGS. 16A and 16B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, electronic test equipment. Thus, the teachings are not intended to be limited to the implementations depicted solely in the Figures, but instead have wide applicability as will be readily apparent to a person having ordinary skill in the art.

An interferometric modulator has a built in interferometric gauge, as described in detail below, that can be used to measure the position of one surface with respect to another and to measure the surface profile of the mirror under different actuation conditions. The position of the surfaces with respect to each other, or the gap distance between them, at a number of different locations can provide information regarding tilt or curvature of one of the surfaces. This information can be used to determine the quality of the interferometric modulator or the manufacturing process used to generate the interferometric modulator. Information regarding the quality of the interferometric modulator can be used to determine whether or not a display device including the interferometric modulator is suitable for use. Information regarding the quality of the manufacturing process used to generate the interferometric modulator can be used to modify the process.

Particular implementations of the subject matter described in this disclosure can be implemented to realize one or more of the following potential advantages. In some implementations, the position of one surface with respect to another can be determined dynamically as at least one of the surfaces move. This can allow for the quality of an interferometric modulator or a manufacturing process to be characterized under conditions more closely matching those of consumer use, such as when the interferometric modulator is used in a display device. In some implementations, the position of one surface with respect to another can be determined using one or more light sources emitting two or more wavelengths of light. This can reduce ambiguity that can be present when only one wavelength of light is used.

One example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

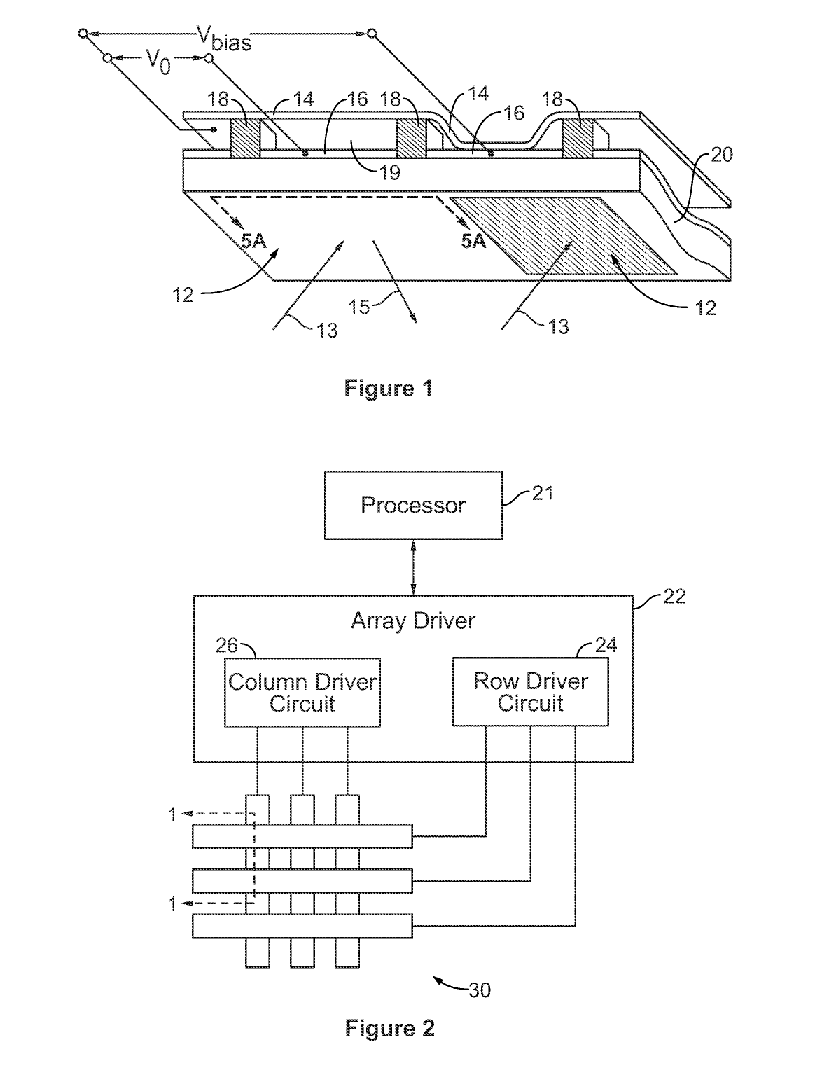

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be on the order of 1-1000 um, while the gap 19 may be on the order of <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14a remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

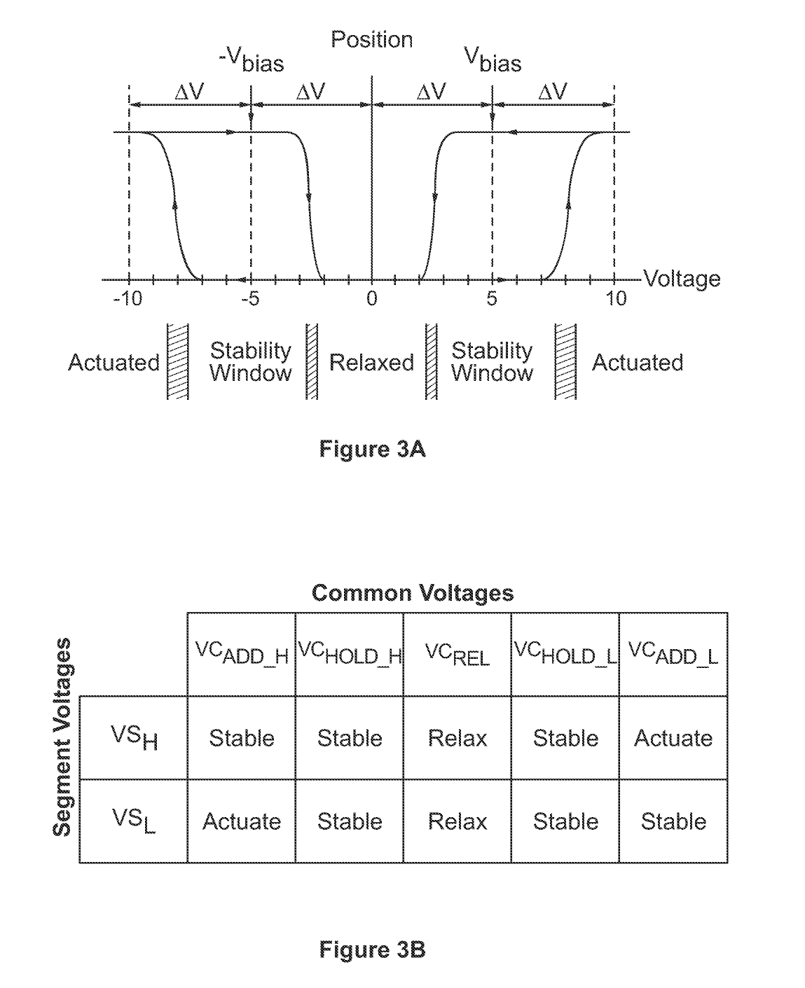

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

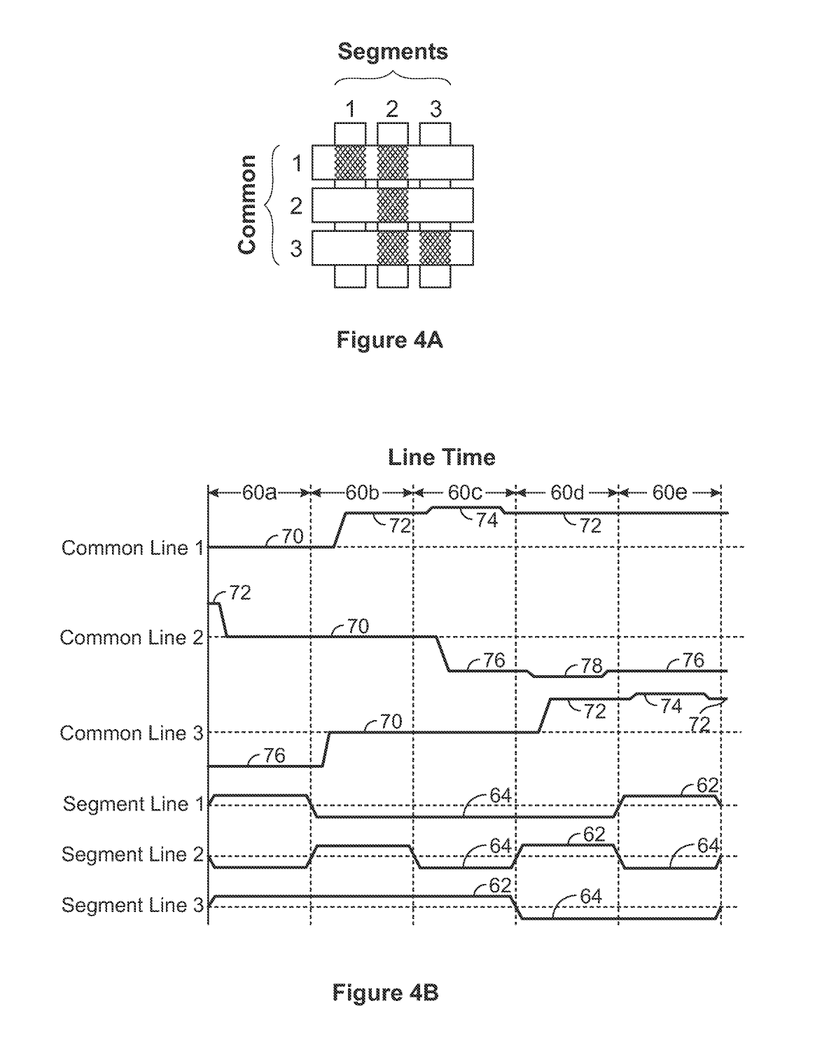

FIG. 3A shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3A. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3A, exists where there is a window of applied voltage within which the device is stable in either the relaxed or actuated state. This is referred to herein as the “hysteresis window” or “stability window.” For a display array 30 having the hysteresis characteristics of FIG. 3A, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 3B shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

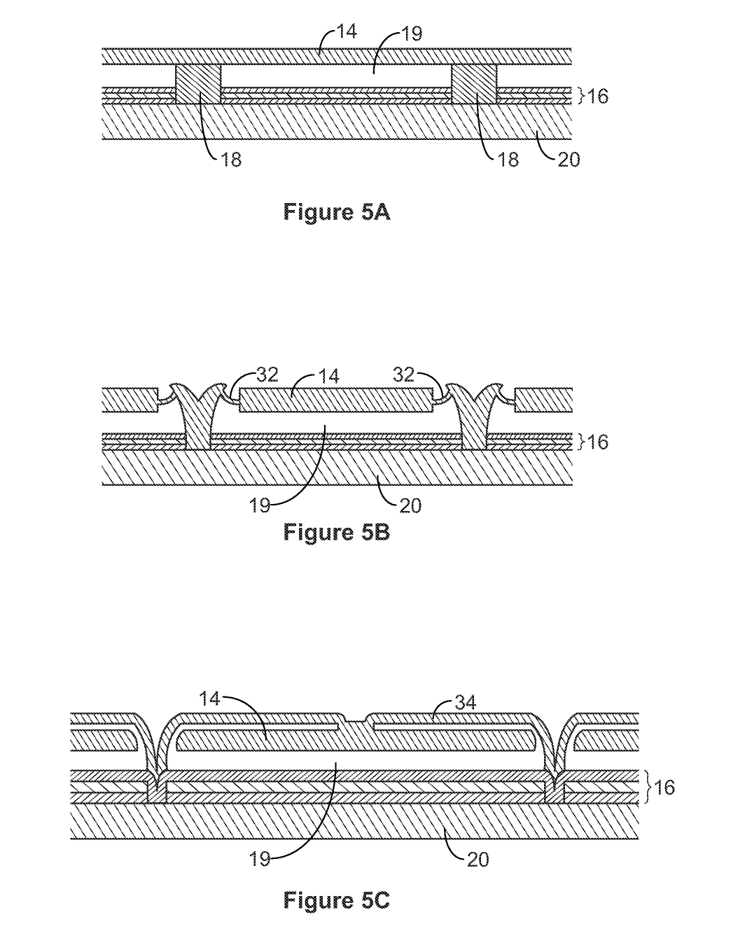

As illustrated in FIG. 3B (as well as in the timing diagram shown in FIG. 4B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3A, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 4A shows an example of a diagram illustrating a frame of display data in the 3×3 interferometric modulator display of FIG. 2. FIG. 4B shows an example of a timing diagram for common and segment signals that may be used to write the frame of display data illustrated in FIG. 4A. The signals can be applied to the, e.g., 3×3 array of FIG. 2, which will ultimately result in the line time 60e display arrangement illustrated in FIG. 4A. The actuated modulators in FIG. 4A are in a dark-state, i.e., where a substantial portion of the reflected light is outside of the visible spectrum so as to result in a dark appearance to, e.g., a viewer. Prior to writing the frame illustrated in FIG. 4A, the pixels can be in any state, but the write procedure illustrated in the timing diagram of FIG. 4B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 3B, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 4A, and will remain in that state as long as the hold voltages are applied along the common lines, regardless of variations in the segment voltage which may occur when modulators along other common lines (not shown) are being addressed.

In the timing diagram of FIG. 4B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 4B. In some other implementations, voltages applied along common lines or segment lines may vary to account for variations in the actuation and release voltages of different modulators, such as modulators of different colors.

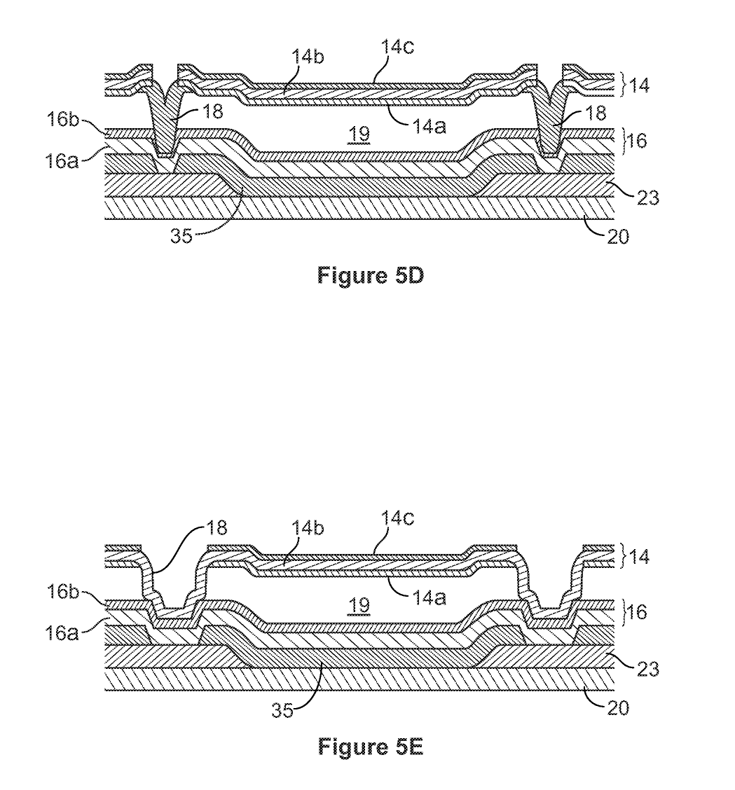

The details of the structure of interferometric modulators that operate in accordance with the principles set forth above may vary widely. For example, FIGS. 5A-5E show examples of cross-sections of varying implementations of interferometric modulators, including the movable reflective layer 14 and its supporting structures. FIG. 5A shows an example of a partial cross-section of the interferometric modulator display of FIG. 1, where a strip of metal material, i.e., the movable reflective layer 14 is deposited on supports 18 extending orthogonally from the substrate 20. In FIG. 5B, the movable reflective layer 14 of each IMOD is generally square or rectangular in shape and attached to supports at or near the corners, on tethers 32. In FIG. 5C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 5C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 5D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an Al alloy with about 0.5% Cu, or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 5D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, CF₄ and/or O₂ for the MoCr and SiO₂ layers and Cl₂ and/or BCl₃ for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 5E shows another example of an IMOD, where the movable reflective layer 14 is self supporting. In contrast with FIG. 5D, the implementation of FIG. 5E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 5E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 5A-5E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 5C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 5A-5E can simplify processing, such as, e.g., patterning.

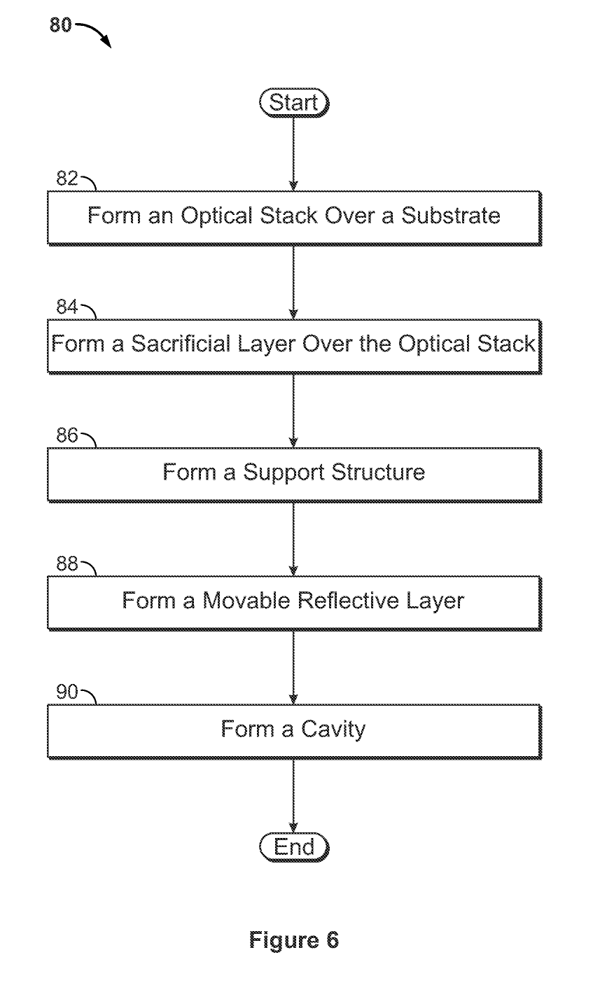

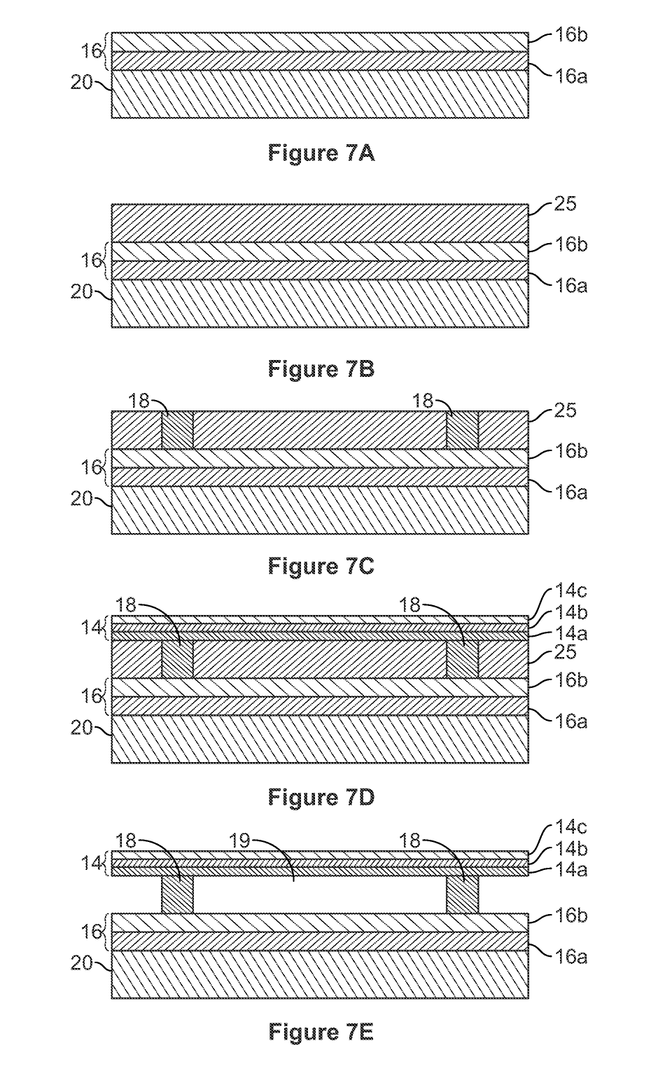

FIG. 6 shows an example of a flow diagram illustrating a manufacturing process 80 for an interferometric modulator, and FIGS. 7A-7E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 5, in addition to other blocks not shown in FIG. 6. With reference to FIGS. 1, 5 and 6, the process 80 begins at block 82 with the formation of the optical stack 16 over the substrate 20. FIG. 7A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 7A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 7B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 7E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 5 and 7C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 5A. Alternatively, as depicted in FIG. 7C, the aperture formed in the sacrificial layer 25 can extend through the sacrificial layer 25, but not through the optical stack 16. For example, FIG. 7E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 7C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 5 and 7D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 7D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 5 and 7E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

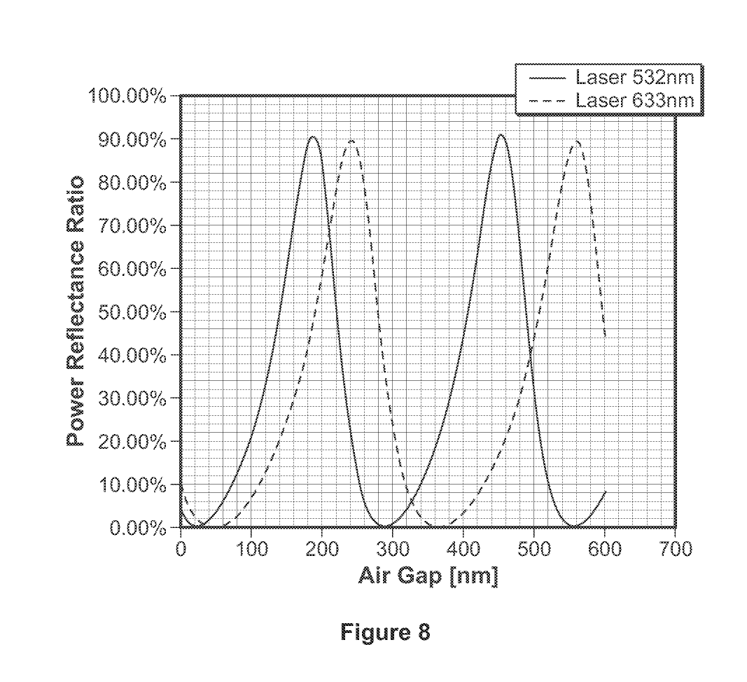

As described above, in some implementations, an interferometric modulator includes a pair of conductive plates separated by a gap distance, one or both of which may be transparent, absorptive, and/or reflective, in whole or part. The amount of light of a particular wavelength reflected by the interferometric modulator is a function of, among other things, the gap distance. The amount of light of particular wavelength reflected by the interferometer is also dependent on any dielectric layers that are deposited on top of the highly reflective mirror surface. Such layers may be designed to yield a particular correspondence between the gap and the reflective spectrum. FIG. 8 shows an example of a graph of a reflectance versus gap distance at two different wavelengths for an implementation of an interferometric modulator wherein the minimum gap distance, the so-called collapsed state, corresponds to a minimum reflection across the visible spectrum, i.e., the so-called black state. The particular implementation of the interferometric modulator for which the reflectance was simulated includes a reflective layer and an absorptive layer separated from the reflective layer by the gap distance, which was ranged between 0 nm and 600 nm. The two wavelengths for which the reflectance was simulated are 532 nm and 633 nm, roughly corresponding to the wavelengths of light emitted by a Double neodymium-doped yttrium aluminum garnet (Nd:Y₃Al₅O₁₂ or Nd:YAG) laser and a helium-neon (HeNe) laser, respectively. Although FIG. 8 illustrates the results of a simulation using two particular wavelengths, other wavelengths can be used.

By illuminating a portion of an interferometric modulator with a particular wavelength of light and measuring the reflectance, the gap distance at that portion of the interferometric modulator can be determined. However, when only one wavelength is used, the gap distance may not be able to be uniquely determined from the reflectance. For example, in the implementation of the interferometric modulator used to generate FIG. 8, if the interferometric modulator is illuminated with a wavelength of 532 nm and a reflectance of 60% is measured, the gap distance may be either approximately 150 nm, 218 nm, 416 nm or 484 nm. Similarly, if the interferometric modulator is illuminated with a wavelength of 633 nm and a reflectance of 8% is measured, the gap distance may be 8 nm, 104 nm, 310 nm or 416 nm. However, if both measurements are made, the gap distance can be uniquely determined as 416 nm. Thus, there is a one-to-one mapping between gap distance and the ordered pair of the reflectance measured at 532 nm and the reflectance measured at 633 nm.

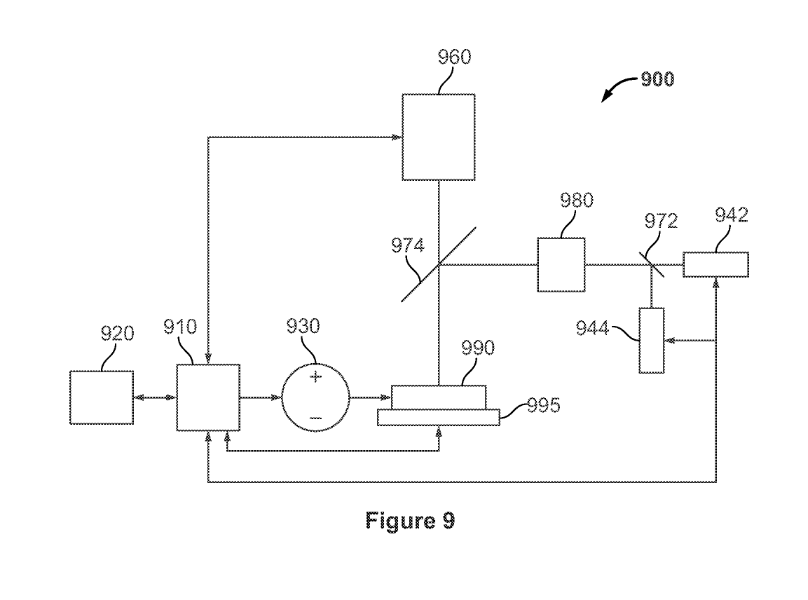

FIG. 9 shows an example of a functional block diagram of a system 900 for determining a distance between two surfaces. The system 900 includes a first laser source 942 which emits a first laser beam having a first wavelength and a second laser source 944 which emits a second laser beam having a second wavelength. The first laser source 942 and second laser source 944 are in data communication with and are controlled by a processor 910 in data communication with a memory 920.

The processor 910 can be a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. The processor 910 can also be implemented as a combination of computing devices, e.g., a combination of a DSP and a microprocessor, a plurality of microprocessors, one or more microprocessors in conjunction with a DSP core, or any other such configuration.

The processor 910 is coupled, via one or more buses, to read information from, or write information to, memory 920. The processor 910 may additionally, or in the alternative, contain memory, such as processor registers. The memory 920 can include processor cache, including a multi-level hierarchical cache in which different levels have different capacities and access speeds. The memory 920 can also include random access memory (RAM), other volatile storage devices, or non-volatile storage devices. The storage can include hard drives, optical discs, such as compact discs (CDs) or digital video discs (DVDs), flash memory, floppy discs, magnetic tape and Zip drives. The memory 920 can store, among other things, processor-executable instructions, which when executed by the processor 910 cause the system 900 to perform a method of determining a distance between two surfaces.

The processor 910 is in data communication with and controls a voltage source 930 that can apply a voltage between two surfaces of a device under test 990. In some implementations, the device under test 990 is an interferometric modulator having a gap distance between two reflective and/or absorptive surfaces that changes depending on the applied voltage. The processor 910 is also in data communication with a linear translation stage 995 (also referred to a linear translation platform) configured to move the device under test. In some implementations, the linear translation stage includes automated x/y translation stages. In some implementations, the linear translation stage is able to move the device under test in three axes.

The first laser source 942 and second laser source 944 are both arranged to emit a laser towards a beam combiner/splitter 972, which either passes or redirects the emitted lasers towards an optical system 980. The optical system 980 can include at least one of a lens or a mirror. The optical system 980 can modify a characteristic of the emitted lasers, such as a beamwidth or an intensity. The emitted lasers, as potentially modified by the optical system 980 are directed towards a beam combiner/splitter 974 which redirects the lasers from the optical system 980 towards the device under test 990. Light reflected from the device under test 990 is passed by the beam combiner/splitter 974 towards a detector 960.

The detector 960 determines at least one characteristic of light reflected by the device under test 990. The characteristics can include, for example, an intensity of the light, a wavelength of the light, or a polarity of the light. In some implementations, the detector 960 determines a first intensity of light of the first wavelength reflected by the device under test 990 and a second intensity of light of the second wavelength reflected by the device under test 990. The intensity of reflected light can be normalized with respect to the intensity of light emitted by the optical system 980 and can, thus, be expressed as a power reflectance ratio. In some implementations, the detector 960 includes a first detector which determines the first intensity and a second detector which determines the second intensity.

The detector 960 can be in data communication with and controlled by the processor 910, such that the determined characteristics can be communicated to the processor 910. The processor 910 can determine a gap distance based on the determined characteristics of light reflected by the device under test 990. Although only a first laser source 942 and a second laser source 944 are shown in FIG. 9, accuracy can be further improved by including additional laser sources of different wavelengths, such as a third laser source of a third wavelength, different from the first and second wavelengths.

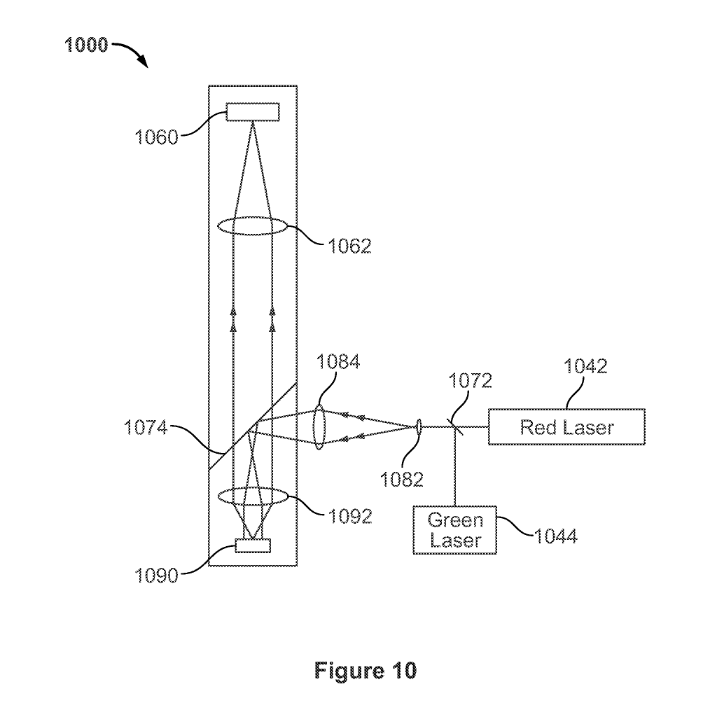

FIG. 10 shows an example of a functional block diagram of a system 1000 for determining a distance between two surfaces at a number of different locations. The system 1000 includes a first laser 1042 which emits a first laser beam at a first wavelength, e.g., 532 nm, and a second laser 1044 which emits a second laser beam at a second wavelength, e.g., 633 nm. The first laser and second laser are directed towards a beam combiner/splitter 1072 which either passes or reflects each laser such that the two lasers are collinear. The lasers are directed from the first beam combiner/splitter 1072 towards a first lens 1082 and a second lens 1084 which expand the collinear laser beams. The expanded laser beams reflect off a second beam combiner/splitter 1074 towards a third lens 1092 which focuses the expanded laser beams near the rear focal plane of the device under test 1090. Thus, the lenses 1082, 1084, 1092 serve to collimate the laser beams such that they fill the aperture and illuminate an area of the device under test 1090. Light reflected from the device under test 1090 passes back through the third lens 1092 through the second beam combiner/splitter 1074 towards a fourth lens 1062 which images the reflected light upon a detector 1060.

The detector 1060 determines a characteristic of light at a number of different locations. In some implementations, the detector 1060 includes a CCD camera. In some other implementations, the detector 1060 is a color camera that separates the two wavelengths of light. In other implementations, the detector 1060 can include a dichroic splitter which directs each wavelength to a different black-and-white camera.

As described above, the detector 1060 can be coupled to a processor (not shown in FIG. 10) which determines a gap distance at each of a number of different locations of the device under test 1090 based on the characteristic of light determined for each of a number of different locations at the detector 1060. The gap distance at each of a number of different locations of a surface of the device under test 1090 can be used to determine the tilt and/or curvature of the surface. The gap distances at each of number of different interferometric modulators of the device under test 1090 can be used to determine whether the different interferometric modulators are uniformly formed.

As mentioned above, in some implementations, the detector 1060 includes a camera. In some implementations, a camera is characterized by the minimum amount of exposure (total optical energy that falls onto a detector element) needed to produce a detector output voltage. If the optical intensity is not sufficiently high, then the fast motion of the interferometric modulator may not yield a signal that can be reliably detected by the camera. As mentioned above, an interferometric modulator can include two layers separated by a gap distance that changes depending on the applied voltage. In some cases, the exposure time of a proposed detector can be substantially greater than the time taken for the gap distance to change from a first distance to a second distance making it difficult to determine the gap distance at a number of different times during the change from a first distance to a second distance. For example, in some implementations, as described above with respect to FIG. 3, an interferometric modulator is a bi-stable device which is stable in actuated and release states. The time taken to change between the actuated and release states is called the response time. Thus, in particular, the exposure time of a proposed detector can be substantially greater than the response time of the device under test.

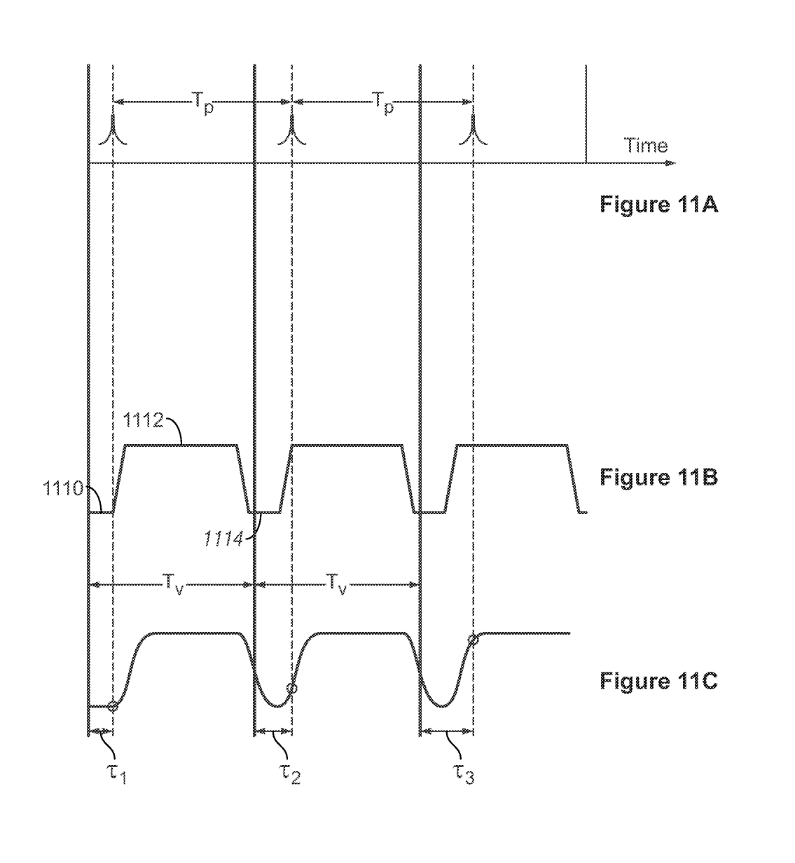

One technique for mitigating this issue is described with respect to the system 900 illustrated in FIG. 9 and the timing diagrams of FIGS. 11A-11C. FIGS. 11A-11C are aligned along a single timeline and generally show how the interferometric mirror position (plotted in FIG. 11C), controlled by a periodic applied voltage (plotted in FIG. 11B) is measured by a series of periodic laser pulses (plotted in FIG. 11A). In particular, FIG. 11A shows an example of a plot of laser emission versus time, FIG. 11B shows an example of a plot of applied voltage versus time, and FIG. 11C shows an example of a plot of gap distance versus time.

Using the system 900 of FIG. 9, the first laser 942 and second laser 944 are controlled by the processor 910 to periodically emit laser beams every Tₚ seconds as illustrated in FIG. 11A. The optical system 980 is arranged to expand the laser beams to illuminate an area of the device under test 990. The detector 960 periodically determines, at a number of different locations, a characteristic of light reflected by the device under test 990.

In some implementations, the voltage source 930 is controlled by the processor 910 to apply a periodic waveform having a period of Tᵥ seconds to the device under test 990 as illustrated in FIG. 11B. The applied voltage waveform 1110 includes voltages 1112 high enough to actuate the device under test 990 and voltages 1114 low enough to release the device under test. Thus, in response to the applied voltage waveform 1110, the device under test 990 actuates and releases periodically every Tᵥ seconds.

Because, in some implementations, Tₚ and Tᵥ are unequal, during each period, the detector 960 determines characteristics of light reflected by the device under test 990 at a different relative time of the transition from a first to a second gap distance as illustrated in FIG. 11C. Thus, the dynamic response of the device under test 990 can be determined. Specifically, any curvature and/or tilting of the surfaces can be determined whether the gap distance is static or dynamic.

If the duration of the laser pulse is sufficiently short, such that the change in gap distance during the laser pulse is negligible, each laser pulse essentially freezes the motion of the mirror from the perspective of the detector 960. In some implementations, the energy in each pulse is higher than the minimum exposure requirement for the detector pixel. In some implementations, the pulse repetition frequency of the laser(s) is slightly slower than the frequency of the driving voltage waveform 1110. One potential drawback of this approach is that transient dynamics are not captured.

As mentioned above, the exposure time of a proposed detector can be substantially greater than the time taken for the gap distance of the device under test to change from a first distance to a second distance, e.g., the response time of the device under test, making it difficult to determine the gap distance at a number of different times during actuation or release. However, high speed detectors, which can determine a characteristic of light in a single location, are available with exposure times less than the time taken for the gap distance of the device to change from a first distance to a second distance, e.g., the response time of the device under test. For example, the exposure times can be on the order of a nanosecond. An array of high speed detectors can be used to determine the characteristic of light at multiple locations. As mentioned above, the system can include a linear translation stage which can move the device under test allowing measurements at different times to fill in the gaps of the determined characteristic between the multiple locations.

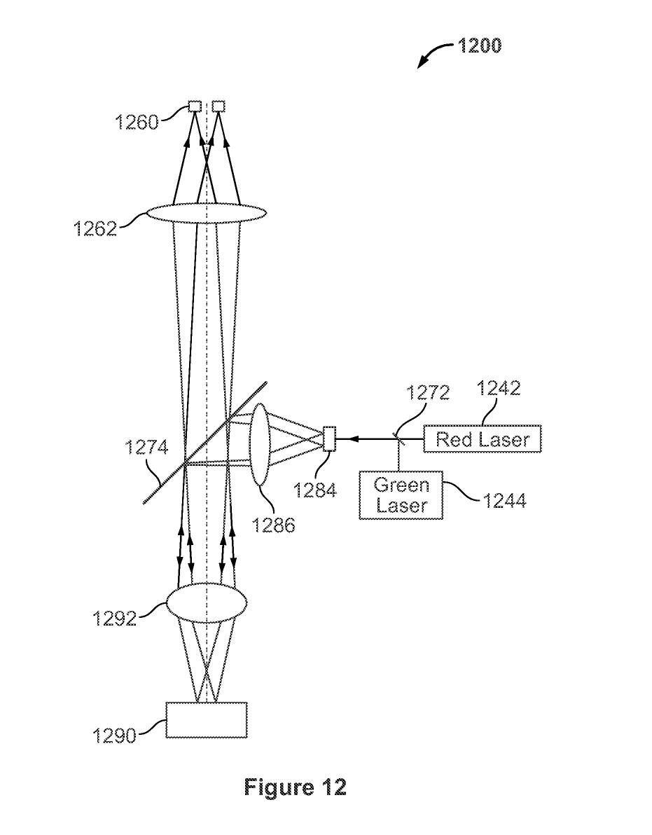

FIG. 12 shows an example of a functional block diagram of a system 1200 for determining a distance between two surfaces at a number of different times during actuation or release. The system 1200 includes a first laser 1242 which emits a first laser beam at a first wavelength, e.g., 532 nm (a red laser), and a second laser 1244 which emits a second laser beam at a second wavelength, e.g., 633 nm (a green laser). The first laser and second laser are directed towards a beam combiner/splitter 1272 which either passes or reflects each laser such that the two lasers are collinear. The lasers are directed from the beam combiner/splitter 1272 towards multi-spot array generator 1284, which expands each of the laser beams into a respective array of multiple laser beams. In some implementations, the array generator 1284 expands each of the laser beams into an array of 9 laser beams. In some other implementations, the array generator 1284 expands each of the laser beams into an array of 16 laser beams. In other implementations, the array generator 1284 is not included in the system, or simply passes each of the lasers as a single beam.

The multiple laser beams are passed through a first lens 1286 and towards a second beam combiner/splitter 1274 which reflects the laser beams towards a second lens 1292 which focuses the expanded laser beams near the rear focal plane of the device under test 1290. Thus, the lenses 1286, 1292 serve to collimate the laser beams such that they illuminate multiple locations within an area of the device under test 1290. Light reflected from the device under test 1290 passes back through the second lens 1292 through the second beam combiner/splitter 1274 towards a third lens 1262 which images the reflected light upon one or more detectors 1260.

The detector 1260 can include an array of high speed detectors, each detector having an exposure time less than the response time of the device under test 1290. In some implementations, the array of high speed detectors includes the same number of detectors as the number of beams generated by the multi-spot array generator 1284. In some other implementations, the array of high speed detectors includes twice the number of detectors as the number of beams generated by the multi-spot array generator 1284 to separately detect the two wavelengths. Each of the high speed detectors can be implemented to determine a characteristic of light.

As described above, the detector 1260 can be coupled to a processor which determines a gap distance at each of a number of different locations of the device under test 1290 at different times during actuation or release of the device under test 1290 based on the determined characteristics of light.

As mentioned above, in some implementations, the detector 1260 includes an array of high speed detectors. For example, the detector 1260 can include one or more avalanche photodiode arrays. A diode can be, in some implementations, an electrical component which acts as a conductor when a positive voltage is applied, substantially allowing current to flow in one direction, but which acts as an insulator when a negative voltage is applied, substantially preventing current from flowing in the opposite direction. An avalanche diode can be, in some implementations, a diode which breaks down at a particular negative voltage and acts as a conductor, substantially allowing current to flow in the opposite direction. An avalanche photodiode can be, in some implementations, an avalanche diode which breaks down when exposed to light and acts as conductor, substantially allowing current to flow in the opposite direction when exposed to light. In some implementations, the detector 1260 also includes a CCD camera to calibrate the dynamic measurement from the high speed detectors and to help align and position the device under test 1290.

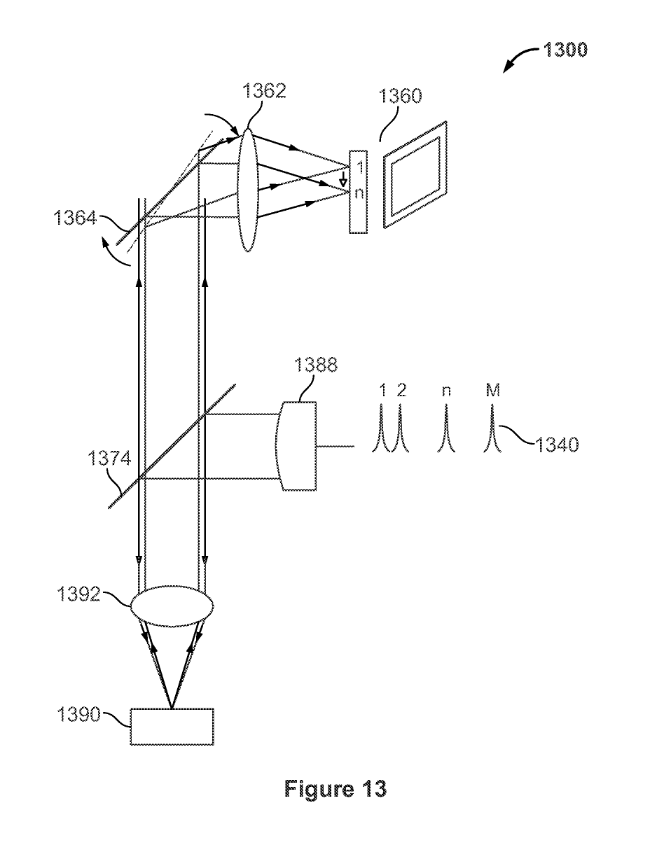

If measurement is restricted to a line across the device under test, non-periodic responses to an applied voltage, e.g., transients, can be captured with a camera having a long exposure time. FIG. 13 shows an example of a functional block diagram of a system 1300 for determining a gap distance or another distance between two surfaces along a line at a number of different times during actuation or release. A periodical laser pulse 1340 is directed towards an anamorphic expander 1388 which expands the beam of light in a single direction to create a plane of light. Thus, the projection of the beam unto a flat surface is expanded from a point to a line. In the implementation illustrated in FIG. 13, the expanded beam is a plane of light parallel to the page. The expanded beam is directed towards a beam combiner/splitter 1374 which reflects the expanded beam towards a first lens 1392 which focuses the expanded beam along a line near the rear focal plane of the device under test 1390. Thus, the anamorphic expander 1388 and first lens 1392 serve to collimate the laser beams such that they illuminate a line along the device under test 1390.

The expanded beam is reflected from the device under test 1390 back through lens 1392 through the beam combiner/splitter 1374 towards an articulating mirror 1364, which reflects the expanded beam through a second lens 1362 towards one or more detectors 1360. The articulating mirror 1364, which can be controlled by a processor (not shown), can change angle between each pulse and thus, during each period, can project the expanded beam (through the second lens 1362) upon a different path to a different portion of the detector 1360.

The detector 1360 can include a two-dimensional array of detectors, such as a CCD camera. Thus, during each period, a different row or column of the array of detectors 1360 is illuminated by the expanded beam reflecting off the articulating mirror 1364. Each detector 1360 can determine a characteristic of light and, accordingly, over a number of periods, a two-dimensional array of light characteristic versus space (the direction of the expanded beam) and time can be produced. During this time, the device under test 1390 can be actuated or released.

After a two-dimensional array of light characteristics are produced, a processor can use this information to generate a two-dimensional array of gap distance versus space and time. The device under test 1390 can be re-oriented in another direction and measurement performed again to image multiple lines across the device under test 1390 as the device is actuated or released.

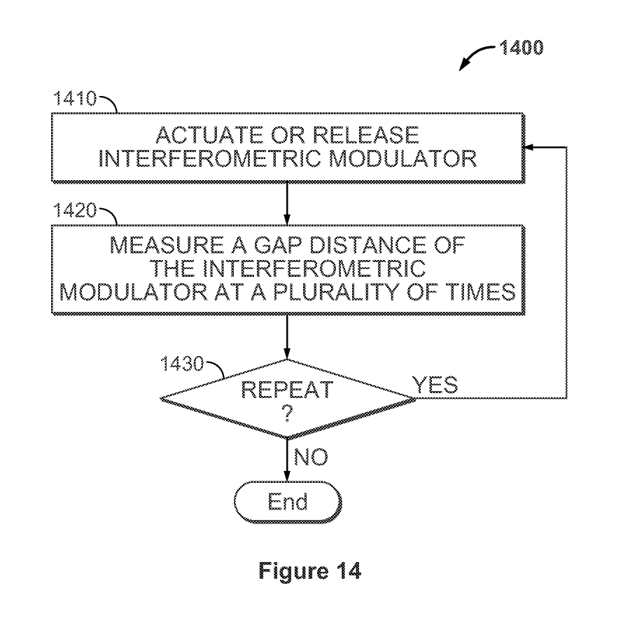

FIG. 14 shows an example of a flowchart illustrating a method 1400 of determining a distance. The method 1400 begins, at block 1410, with the actuation or release of an interferometric modulator. The actuation or release can be performed by applying a voltage high enough to actuate the interferometric modulator or a voltage low enough to release the interferometric modulator. The actuation or release can be performed, for example, by the processor 910 in conjunction with the voltage source 930 depicted in FIG. 9.

In block 1420, a gap distance of the interferometric modulator is determined at a plurality of times during the actuation or release. The gap distances can be determined, for example, by the processor 910, based on a characteristic of light determined by the detector 960 depicted in FIG. 9. In some implementations, the characteristic of light is an intensity of the light. In some implementations, the characteristic of light is a wavelength or a polarity of the light. Using this information, a response time of the interferometric modulator can be determined.

In some implementations, actuating or releasing the interferometric modulator in block 1410 includes periodically actuating or releasing the interferometric modulator at a first periodicity and measuring a gap distance of the interferometric modulator at a plurality of times during the actuation or release in block 1420 includes periodically measuring a gap distance of the interferometric modulator at a second periodicity different from the first periodicity. For example, the interferometric modulator can be actuated and released by applying the voltage waveform 1110 depicted in FIG. 11.

In some implementations, measuring a gap distance in block 1420 includes measuring a plurality of gap distances at a respective plurality of locations of the interferometric modulator. For example, the plurality of locations can include an array of locations as described above with respect to FIG. 12 or a line of locations as described above with respect to FIG. 13. Using this information, the tilt and/or curvature of a surface of the interferometric modulator can be determined at a plurality of times.

The method 1400 continues to block 1430 where it is determined whether or not to repeat the method 1400. For example, it can be determined to repeat the method 1400 for another interferometric modulator. If it is determined to repeat the method 1400, the method returns to block 1410. Otherwise, the method 1400 ends.

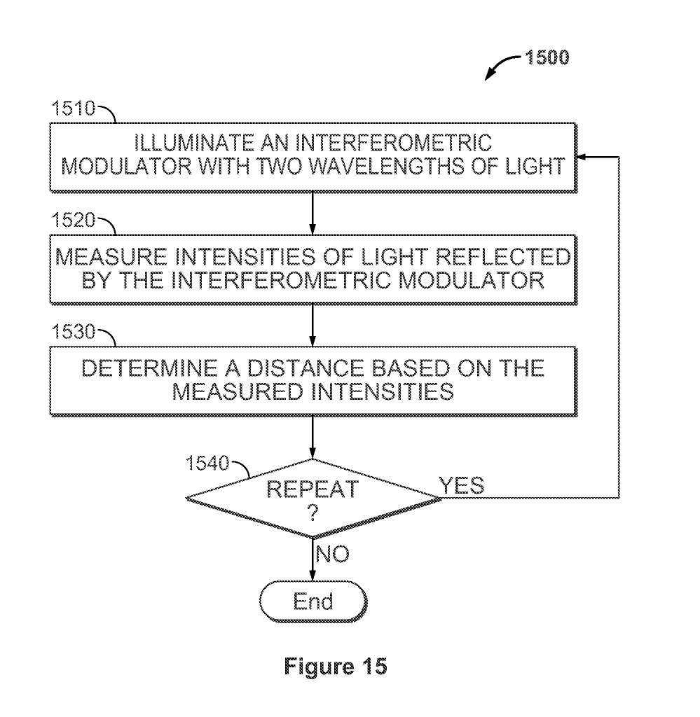

FIG. 15 shows an example of a flowchart illustrating a method 1500 of determining a distance. The method 1500 begins, in block 1510 with the illumination of an interferometric modulator with two wavelengths of light. The illumination can be performed, for example, by the first laser source 942 and second laser source 944 depicted in FIG. 9. In some implementations, the two wavelengths of light can be different, while in other implementations, the wavelengths can be the same. In some implementations, the interferometric modulator has a distance between a first surface which is at least partially reflective and a second surface which is at least partially absorptive.

The method 1500 continues to block 1520 where intensities of light reflected by the interferometric modulator are determined. The intensities of light can be determined, for example, by the detector 960 depicted in FIG. 9. In some implementations, the intensities of light are the intensity of light of the two wavelengths by which the interferometric modulator is illuminated in block 1510.

In block 1530, a distance is determined based on the measured intensities. The distance can be determined, for example, by the processor 910 depicted in FIG. 9. In some implementations, the determined distance is the distance between a first surface of the interferometric modulator which is at least partially reflective and a second surface of the interferometric modulator which is at least partially absorptive. In some implementations, the distance is determined based on a look-up table stored in the memory 920 of FIG. 9 associating a specific distance with each ordered pair of intensities.

Although the method 1500 is described above using two wavelengths of light, more than two wavelengths of light could be used, such as three different wavelengths of light from three laser sources or four different wavelengths of light from four laser sources, etc.

The method 1500 continues to block 1540 where it is determined whether or not to repeat the method 1500. For example, it can be determined to repeat the method 1500 for another interferometric modulator. If it is determined to repeat the method 1500, the method returns to block 1510. Otherwise, the method 1500 ends.

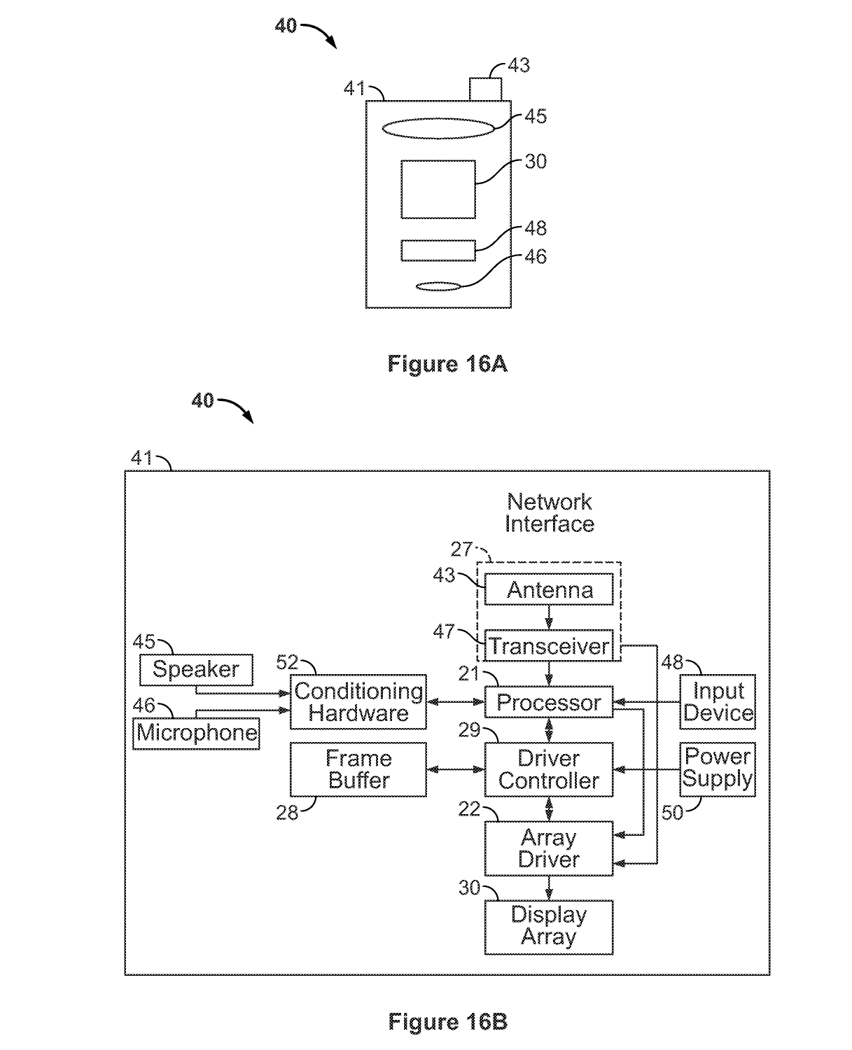

FIGS. 16A and 16B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 16B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of determining a distance, the method comprising:
actuating or releasing an interferometric modulator having a first surface and a second surface; and
measuring a distance between the first and second surface at a plurality of times during the actuation or release.

2. The method of claim 1, wherein actuating or releasing an interferometric modulator includes periodically actuating and releasing the interferometric modulator at a first periodicity and wherein measuring a gap distance of the interferometric modulator at a plurality of times during the actuation or release includes periodically measuring a gap distance of the interferometric modulator at a second periodicity different from the first periodicity.

3. The method of claim 1, wherein measuring a gap distance of the interferometric modulator includes measuring a plurality of gap distances at a respective plurality of locations within the interferometric modulator.

4. The method of claim 3, wherein the plurality of locations includes a two-dimensional array of locations.

5. The method of claim 3, wherein the plurality of locations includes a plurality of locations along a line.

6. The method of claim 5, wherein the plurality of locations includes a plurality of location sets, each location along a line, wherein each of the plurality of location sets is measured at a respective one of the plurality of times.

7. A system for determining a distance, the system comprising:
a voltage source configured to actuate or release an interferometric modulator having a first surface and a second surface; and
a processor configured to determine a distance between the first and second surfaces at a plurality of times during the actuation or release.

8. The system of claim 7, further comprising:
a first laser source configured to emit a first laser beam having a first wavelength;
a second laser source configured to emit a second laser beam having a second wavelength different from the first wavelength; and
a detector configured to determine a first intensity of the first laser beam reflected from the interferometric modulator and a second intensity of the second laser beam reflected from the interferometric modulator,
wherein the processor is configured to determine the distance between the first and second surfaces based on the first and second intensities.

9. The system of claim 8, wherein the detector includes an avalanche photodiode array.

10. The system of claim 7, wherein the voltage source is configured to periodically actuate and release the interferometric modulator at a first periodicity and wherein the processor is configured to periodically determine a distance between the first and second surfaces at a second periodicity different from the first periodicity.

11. The system of claim 7, wherein the processor is configured to determine a plurality of distances between the first and second surfaces at a respective plurality of locations of the interferometric modulator.

12. The system of claim 7, further comprising a multi-spot array generator.

13. The system of claim 7, further comprising an anamorphic expander.

14. The system of claim 7, further comprising a pulsed laser, a mirror, and a CCD camera, wherein the processor is configured to pulse the laser at the plurality of times and wherein the mirror is configured to image the reflected laser beam for each of pulses onto a respective row of the CCD camera.

15. The system of claim 7, further comprising a linear translation platform configured to move the interferometric modulator.

16. A system for determining a distance, the system comprising:
means for actuating or releasing an interferometric modulator having a first surface and a second surface; and
means for determining a distance between the first and second surfaces at a plurality of times during the actuation or release.

17. The system of claim 16, further comprising:
means for emitting a first laser beam having a first wavelength;
means for emitting a second laser beam having a second wavelength different from the first wavelength; and
means for determining a first intensity of the first laser beam reflected from the interferometric modulator and a second intensity of the second laser beam reflected from the interferometric modulator,
wherein the means for determining a distance is configured to determine the distance between the first and second surfaces based on the first and second intensities.

18. The system of claim 16, further comprising means for expanding a laser beam into a plurality of beams.

19. The system of claim 16, further comprising means for expanding a laser beam into a plane.

20. A computer-readable storage medium having computer-executable instructions encoded thereon for performing a method of determining a distance, the method comprising:
actuating or releasing an interferometric modulator; and
measuring a gap distance of the interferometric modulator at a plurality of times during the actuation or release.

21. The computer readable storage medium of claim 20, wherein actuating or releasing an interferometric modulator includes periodically actuating and releasing the interferometric modulator at a first periodicity and wherein measuring a gap distance of the interferometric modulator at a plurality of times during the actuation or release includes periodically measuring a gap distance of the interferometric modulator at a second periodicity different from the first periodicity.

22. The computer readable storage medium of claim 20, wherein measuring a gap distance of the interferometric modulator includes measuring a plurality of gap distances at a respective plurality of locations within the interferometric modulator.

23. The computer readable storage medium of claim 22, wherein the plurality of locations includes a two-dimensional array of locations.

24. The computer readable storage medium of claim 22, wherein the plurality of locations includes a plurality of locations along a line.

25. A method of determining a distance between two surfaces, the method comprising:
illuminating, with a first laser beam having a first wavelength and with a second laser beam having a second wavelength different from the first wavelength, an interferometric modulator having a distance between a first surface which is at least partially reflective and a second surface which is at least partially absorptive;
measuring a first intensity of the first laser beam modulated by the interferometric modulator and a second intensity of the second laser beam modulated by the interferometric modulator; and
determining the distance based on the measured intensities.

26. The method of claim 25, wherein the first wavelength is approximately 633 nm and the second wavelength is approximately 532 nm.

27. The method of claim 25, further comprising illuminating the interferometric modulator with a third laser beam having a third wavelength and measuring a third intensity of the third laser beam modulated by the interferometric modulator.

28. The method of claim 25, further comprising determining at least a first power reflectance ratio by normalizing the first intensity of the first laser beam modulated by the interferometric modulator with respect to an intensity of the illuminating first laser beam.

29. The method of claim 25, wherein determining the distance includes determining the distance at a plurality of times during an actuation or release of the interferometric modulator.

30. A system for determining a distance between two surfaces, the system comprising:
a first laser source configured to emit a first laser beam having a first wavelength towards an interferometric modulator having a distance between a first surface which is at least partially reflective and a second surface which is at least partially absorptive;
a second laser source configured to emit a second laser beam having a second wavelength towards the interferometric modulator;
a detector configured to measure a first intensity of the first laser beam modulated by the interferometric modulator and a second intensity of the second laser beam modulated by the interferometric modulator; and
a processor configured to determine the distance based on the measured intensities.

31. The system of claim 30, wherein the first laser source is a HeNe source and wherein the second laser source is a Double Nd:YAG source.

32. The system of claim 30, further comprising a linear translation platform configured to move the interferometric modulator.

33. The system of claim 30, wherein at least one of the first detector and the second detector includes an avalanche photodiode array.

34. The system of claim 30, further comprising a third laser source configured to emit a third laser beam having a third wavelength towards the interferometric modulator, wherein the detector is further configured to measure a third intensity of the third laser beam modulated by the interferometric modulator.

35. The system of claim 30, wherein the processor is further configured to determining at least a first power reflectance ratio by normalizing the first intensity of the first laser beam modulated by the interferometric modulator with respect to an intensity of the emitted first laser beam.

36. A system for determining a distance between two surfaces, the system comprising:
means for illuminating, with a first laser beam having a first wavelength and with a second laser beam having a second wavelength different from the first wavelength, an interferometric modulator having a distance between a first surface which is at least partially reflective and a second surface which is at least partially absorptive;
means for measuring a first intensity of the first laser beam modulated by the interferometric modulator and a second intensity of the second laser beam modulated by the interferometric modulator; and
means for determining the distance based on the measured intensities.

37. The system of claim 36, further comprising means for linearly translating the interferometric modulator.

38. The system of claim 36, wherein the means for illuminating is configured to illuminate, with a third laser beam having a third wavelength, the interferometric modulator and wherein the means for measuring is configured to measure a third intensity of the third laser beam modulated by the interferometric modulator.

39. The system of claim 36, wherein the means for determining is further configured to determining at least a first power reflectance ratio by normalizing the first intensity of the first laser beam modulated by the interferometric modulator with respect to an intensity of the illuminating first laser beam.

40. A computer-readable storage medium having computer-executable instructions encoded thereon for performing a method of determining a distance between two surfaces, the method comprising:
illuminating, with a first laser beam having a first wavelength and with a second laser beam having a second wavelength different from the first wavelength, an interferometric modulator having a distance between a first surface which is at least partially reflective and a second surface which is at least partially absorptive;
measuring a first intensity of the first laser beam modulated by the interferometric modulator and a second intensity of the second laser beam modulated by the interferometric modulator; and
determining the distance based on the measured intensities.

41. The computer-readable storage medium of claim 40, wherein the method further includes illuminating the interferometric modulator with a third laser beam having a third wavelength and measuring a third intensity of the third laser beam modulated by the interferometric modulator.

42. The computer-readable storage medium of claim 40, wherein the method further includes determining at least a first power reflectance ratio by normalizing the first intensity of the first laser beam modulated by the interferometric modulator with respect to an intensity of the illuminating first laser beam.

43. The computer-reading storage medium of claim 40, wherein determining the distance includes determining the distance at a plurality of times during an actuation or release of the interferometric modulator.
